(19) United States
(12) Patent Application Publication
(10) Pub. No.: US 2015/0135700 A1
(43) Pub. Date: May 21, 2015

(54) Enhancements to High Efficiency Hydro-mechanical Vehicle Transmission

(71) Applicant: ROBERT HUGH FRANCIS LLOYD, Los Altos, CA (US)

(72) Inventor: ROBERT HUGH FRANCIS LLOYD, Los Altos, CA (US)

(21) Appl. No.: 14/086,503

(22) Filed: Nov. 21, 2013

(51) Int. Cl. F16H 47/02; F16H 39/04

(52) U.S. Cl. CPC F16H 47/02; F16H 39/04; F16H 2047/025
USPC 60/437; 60/493; 60/469; 60/486; 60/484

(57) ABSTRACT

This invention consists of the addition of a novel clutch arrangement which facilitates speed changing gears on both the output and input of the transmission and provides for a compact packaging configuration for a plurality of hydraulic pump/motors. The use of a small accumulator without a valve and a related reservoir absorbs the pressure shocks from rapidly opening and closing the valves that that select or de-select the pump/motors. It is also disclosed that two adjacent pump/motors on the same shaft can be constructed such that they share an input or output port thereby reducing the size of the combination. The transmission can perform the retarder function by placing a flow retarding valve in the re-circulating path in one or more of the pump/motors.

This application is a Continuation Application that claims the benefits of co-pending Non-provisional application Ser. No. 13/670,443 filed Nov. 06, 2012 and entitled “High Efficiency Hydro-mechanical Vehicle Transmission” and Provisional Application 61/897,753 filed Oct. 30, 2013 and entitled “Selectable One-way & Dog Clutch”

### TECHNICAL FIELD

The present inventions relates a hydro-mechanical vehicle transmission based on fixed-displacement hydraulic pump/motors which also facilitates the implementation of hydraulic regenerative braking.

### BACKGROUND OF THE INVENTION

Most present hydraulic transmission intended for vehicles are based on variable displacement hydraulic devices. None of them have been successfully applied to road vehicles due to problems associated with the variable displacement devices. These problems relate to efficiency, cost, form factor, noise and reliability.

### SUMMARY OF THE INVENTION

This invention represents enhancements to that of application Ser. No. 13/670,443.

1, Although this transmission is intended to be used in conjunction with regenerative braking, under certain conditions (a full accumulator for example) the retarder function i.e. additional braking is desired (used in most truck and bus transmissions). This is performed by inserting a variable flow restrictor in one or more of the unselected pump/motors. The restriction of the flow provides the desired braking action.

2, Since it is desirable to be able to operate hydraulic pumps and motors at their maximum rated rpm (for maximum power), the use of speed changing gears on both the output and input of the transmission is disclosed.

3, The gears of 2 above also allows the input and output pump/motors to be interleaved for improved packing density.

4, A novel design of a selectable one-way clutch allows the interleaving of 3 above. This clutch allows all the hydraulic motors to participate in the initial acceleration of the vehicle, providing a high level of torque and also as an all mechanical bypass of the hydraulic transmission for improved efficiency.

5, The large number of pump/motors allows for very small separation between the various “gears” which in turn allows the use of a very small accumulator to absorb the shifting shock and eliminates the necessity of a reservoir. This facilitates the use of the transmission as a conventional transmission (as a quasi-continuously variable transmission) without necessarily implementing regenerative braking.

6, An arrangement is disclosed where two adjacent pump/motors share a port to reduce the size of the combination allowing more power handling capability in the same physical volume.

### BRIEF DESCRIPTION OF THE DRAWINGS

FIG. 1 illustrates the flow restricting valve used to accomplish the retarding function according to the invention.

FIG. 2 illustrates the speed changing gears on the input and output of the transmission according to the invention.

FIG. 3 illustrates how the gearing allows the “interleaving” of the input and output pump/motors according to the invention.

FIG. 4 illustrates the specialized selectable one-way clutch according to the invention.

FIG. 5 illustrates two hydraulic pump/motors both with and without sharing a port according to the invention.

FIG. 6 illustrates a small accumulator for the case where regenerative braking is not used according to the invention.

### DESCRIPTION OF THE PREFERRED EMBODIMENTS

In this description, the term pump/motor refers to hydraulic devices that can function either as a hydraulic pump or hydraulic motor.

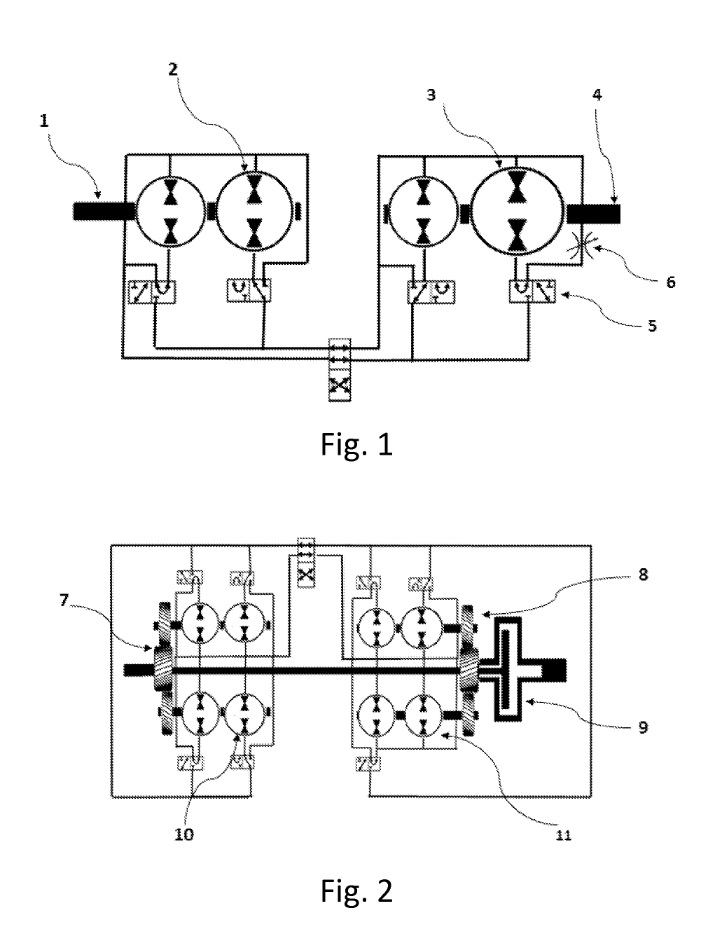

1 in FIG. 1 is the input shaft of a four pump/motor 2, 3 version of this transmission. Retarding or braking is accomplished by a valve 5 being positioned to cause the fluid in pump/motor 5 to recirculate. Closing flow restricting valve 6 will resist the turning motion of the output shaft 4 thereby applying a braking force to the vehicle.

FIG. 2 is a schematic of an 8 pump/motor version of this transmission illustrating the speed-changing gears 7 & 8. 9 is a schematic representation of a selectable one-way clutch whose purpose is, when engaged, to provide a mechanical by-pass of the transmission during cruising and allow both input pump/motors 10 and output pump/motors 11 to contribute to the initial acceleration of the vehicle.

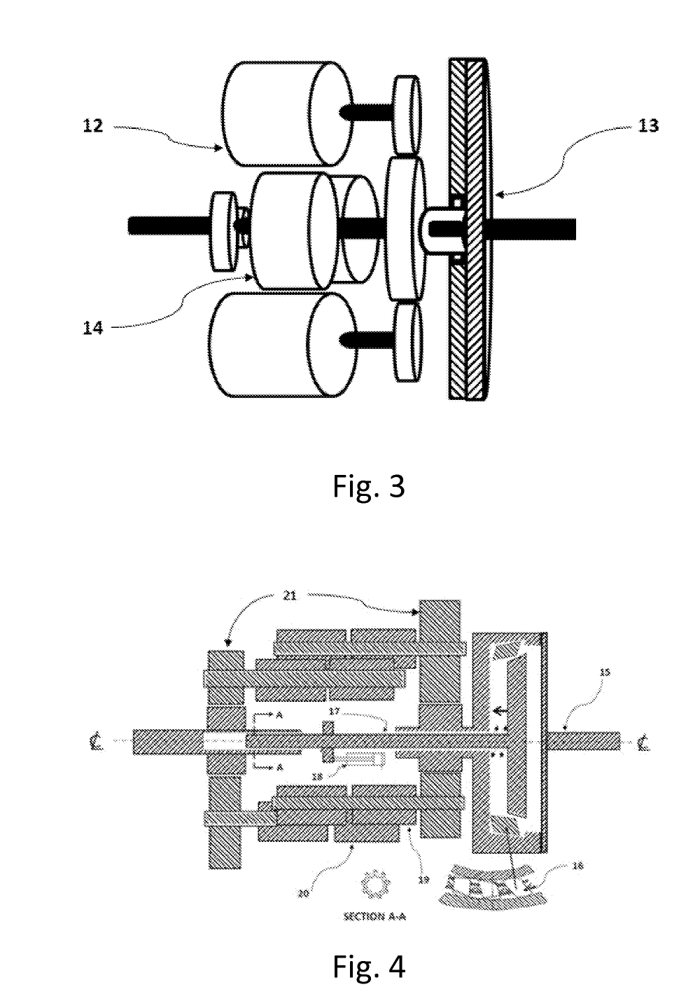

FIG. 3 illustrates how the clutch 13 allows the input pump/motors 14 to be “interleaved” with the output pump/motors 12 permitting a higher packing density.

FIG. 4 illustrates the details of how the selectable one-way clutch 16 is arranged to allow the input pump/motors 20 to be “interleaved” with the output pump/motors 19. The input side of the clutch 17 is engaged with the output side 15 by actuator 18. 21 are the speed changing gears.

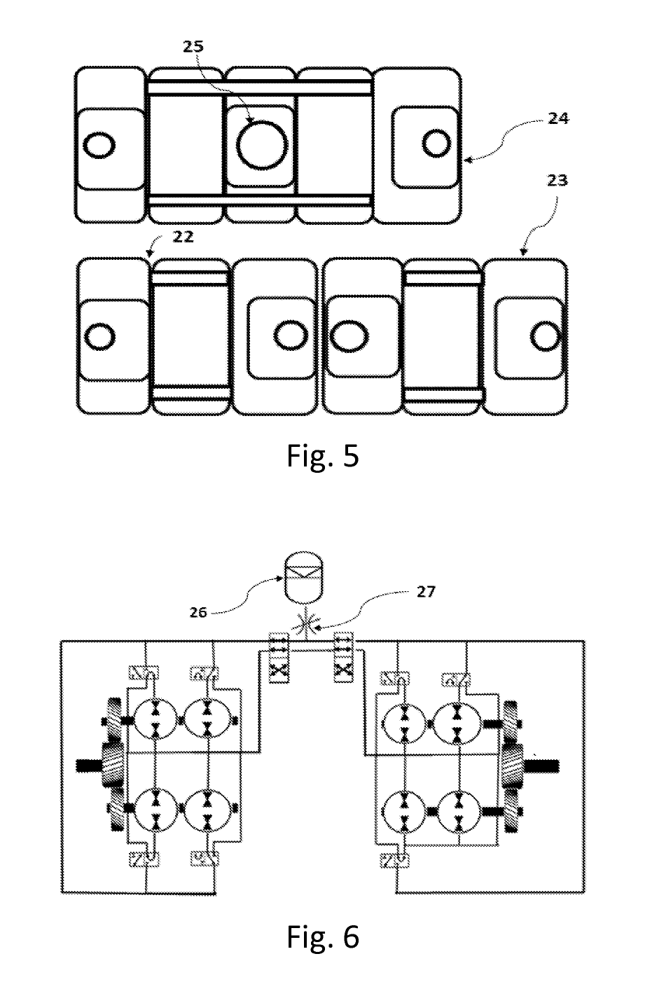

When two or more pump/motors are mounted on the same shaft, they can be constructed such as to share one port. This eliminates the need for one seal and bearing, thereby saving critical space. FIG. 5 illustrates the space savings by comparing two separate pump/motors 22 & 23 with combined unit 24 sharing one port 25.

With a large number of pump/motors, the separations between the various “gears” can be made very small such that a small accumulator, (26 in FIG. 6), will suffice to absorb the pressure shock produced by rapid shifting under load. A flow restricting valve 27 may or may not be required. This situation would arise when regenerative braking is not performed. In some cases it may be used in conjunction with a large accumulator for regenerative braking. Locating a small accumulator very close to the pump/motors may be desirable to reduce noise and vibration among other things even though a large accumulator exists at some distance from the transmission.

What is claimed is:

1. A hydraulic transmission consisting of:
a, one or more pump/motors attached to an input shaft;
b, one or more pump/motors attached to an output shaft;
c, various flow paths and diverting valves to cause the fluid to either flow thru the pump or motor to other pump/motors or to re-circulate within the pump/motor;
d, a valve to allow the flow between output and input pump/motors to reverse direction;
e, a variable flow restricting valve in the recirculating path of one or more of the pump motors to provide the retarding function.

2. The transmission of claim 1 with or without the variable flow restricting valve and,
a, speed changing gears between the input shaft and the input pump/motors; and
b, speed changing gears between the output shaft and the output pump/motors.

3. The transmission of claim 2 wherein the input and output pump/motor are located on the adjacent sides of the speed changing gears in a manner that allows the input and output pump/motors to be interspersed in the same volume.

4. The transmission of claim 3 wherein:
a, the input shaft is in line with the output shaft and extended concentrically through the output shaft to a point beyond the output speed changing gear;
b, the portion of the input shaft that is extended through the output shaft is such that it can vary the length of the input shaft;
c, the end of the input shaft that is beyond the output speed changing gear is attached to one side of a clutch that can be either a one-way clutch or a fixed or dog clutch;
d, the other side of the clutch in c directly above, is such that it connects to the output shaft that connects to the output speed changing gear and also becomes the output of the transmission;
e, with a means to move the extension of the input shaft in such a manner that it causes the clutch to engage and dis-engage.

5. The transmission of claim 1, with or without the variable flow restricting valve, with two or more pump/motors on the same shaft where adjacent pump/motors and constructed such that they can share an input or output port and thereby reduce the combined size.

6. The transmission of claim 1, with or without the variable flow restricting valve, where an accumulator is attached to the hydraulic flow path for the purposes of reducing noise and vibration among others.
